(19) United States
(12) Patent Application Publication
(10) Pub. No.: US 2026/0164324 A1
(43) Pub. Date: Jun. 11, 2026

(54) CELL GROUP CONFIGURATION METHOD AND APPARATUS

(71) Applicant: Electronics and Telecommunications Research Institute, Daejeon (KR)

(72) Inventor: Jun Sik KIM, Daejeon (KR)

(73) Assignee: Electronics and Telecommunications Research Institute, Daejeon (KR)

(21) Appl. No.: 19/408,957

(22) Filed: Dec. 4, 2025

(30) Foreign Application Priority Data
Dec. 5, 2024 (KR) 10-2024-0179337
Dec. 2, 2025 (KR) 10-2025-0188424

(51) Int. Cl. H04W 36/08; H04W 24/10; H04W 36/30

(52) U.S. Cl. CPC H04W 36/08; H04W 24/10; H04W 36/30

(57) ABSTRACT

A method of a terminal may comprise: transmitting a measurement report to a base station; receiving, from the base station, first configuration information generated based on the measurement report, wherein the first configuration information is configuration information for target cell selection by the terminal; determining a target cell based on the first configuration information; transmitting, to the base station, a command instructing switching to the target cell; and performing communication with the target cell.

### CROSS-REFERENCE TO RELATED APPLICATIONS

This application claims priority to Korean Patent Applications No. 10-2024-0179337, filed on Dec. 5, 2024, and No. 10-2025-0188424, filed on Dec. 2, 2025, with the Korean Intellectual Property Office (KIPO), the entire contents of which are hereby incorporated by reference.

### BACKGROUND

### 1. Technical Field

The present disclosure relates to an enhanced communication technique, and more particularly, to a technique for configurating cell groups.

### 2. Related Art

A communication network (e.g. 5G communication network, 6G communication network, and the like) for providing improved communication services compared to an existing communication network (e.g. long term evolution (LTE), LTE Advanced (LTE-A), and the like) is being developed. The 5G communication network (e.g. new radio (NR) communication network) can support frequency bands of 6 GHz or lower as well as frequency bands above 6 GHz. In other words, the 5G communication network can support frequency range 1 (FR1) and/or frequency range 2 (FR2). The 5G communication network can support various communication services and scenarios compared to the LTE communication network. For example, usage scenarios of the 5G communication network may include enhanced Mobile Broadband (eMBB), Ultra-Reliable Low Latency Communication (URLLC), and massive Machine Type Communication (mMTC).

When communication is performed in an ultra-high frequency band, radio waves used for communication may have strong directionality. Radio waves having strong directionality may suffer large path loss. Accordingly, communication in the ultra-high frequency band may be used only in limited fields. In order to compensate for disadvantages of communication in the ultra-high frequency band, multi-transmission and reception point (TRP)-based beamforming technology may be introduced. In a communication environment in which multi-TRP-based beamforming is performed, cell-centric radio access rather than user-centric radio access may be performed. The cell-centric radio access may not flexibly respond to changes in a reception environment due to movement of a terminal. In order to solve the above problem, as terminal-centric radio access, methods of reconfiguring component carriers (CCs) and methods of reducing outage caused by handover according to the present disclosure may be required.

### SUMMARY

The present disclosure for resolving the above-described problems is directed to providing methods and apparatuses for configuring cell groups based on measurement information of a terminal.

A method of a terminal, according to exemplary embodiments of the present disclosure, may comprise: transmitting a measurement report to a base station; receiving, from the base station, first configuration information generated based on the measurement report, wherein the first configuration information is configuration information for target cell selection by the terminal; determining a target cell based on the first configuration information; transmitting, to the base station, a command instructing switching to the target cell; and performing communication with the target cell.

The measurement report may include measurement results for cells configured for the terminal, and the measurement results may include a quality of a signal received from each of the cells.

The first configuration information may include at least one of: information on a secondary cell group, state information of each of secondary cells included in the secondary cell group, broadcast-related configuration information for the secondary cells, or access information for the terminal to access each of the secondary cells.

The state information may indicate one of an active state, an inactive state, a candidate state, or a configured state, the candidate state may indicate a state in which a secondary cell is capable of being transitioned to a primary cell, and the configured state may indicate a state in which the secondary cell is configured as the primary cell.

The broadcast-related configuration information may include at least one of: information indicating whether each of the secondary cells performs broadcasting, or a broadcast start time of a secondary cell determined to perform broadcasting among the secondary cells.

Control information may not be transmitted from a secondary cell that is in the candidate state capable of being transitioned to the primary cell.

The target cell may be determined from among secondary cells that are indicated by the first configuration information and are in the candidate state capable of being transitioned to the primary cell.

The method may further comprise: receiving, from the base station after receiving the first configuration information, a first instruction indicating terminal-selection-based cell switching, and the target cell may be determined further based on the first instruction.

The method may further comprise: checking whether synchronization with cells configured for the terminal is acquired after receiving the first configuration information; and performing synchronization with the cells based on a result of the checking.

A method of a base station, according to exemplary embodiments of the present disclosure, may comprise: receiving a measurement report from a terminal; determining a secondary cell group based on the measurement report; transmitting, to the terminal, first configuration information including information on the secondary cell group, wherein the first configuration information is configuration information for target cell selection by the terminal; receiving, from the terminal, a command instructing switching to a target cell selected by the terminal; and performing communication with the terminal through the target cell.

The first configuration information may include at least one of: state information of each of secondary cells included in the secondary cell group, broadcast-related configuration information for the secondary cells, or access information for the terminal to access each of the secondary cells.

The state information may indicate one of an active state, an inactive state, a candidate state, or a configured state, the candidate state may indicate a state in which a secondary cell is capable of being transitioned to a primary cell, and the configured state may indicate a state in which the secondary cell is configured as the primary cell.

The broadcast-related configuration information may include at least one of: information indicating whether each of the secondary cells performs broadcasting, or a broadcast start time of a secondary cell determined to perform broadcasting among the secondary cells.

The method may further comprise: determining, after receiving the measurement report, whether each of secondary cells associated with the measurement report performs broadcasting.

A terminal, according to exemplary embodiments of the present disclosure, may comprise at least one processor, wherein the at least one processor may cause the terminal to perform: transmitting a measurement report to a base station; receiving, from the base station, first configuration information generated based on the measurement report, wherein the first configuration information is configuration information for target cell selection by the terminal; determining a target cell based on the first configuration information; transmitting, to the base station, a command instructing switching to the target cell; and performing communication with the target cell.

The measurement report may include measurement results for cells configured for the terminal, and the measurement results may include a quality of a signal received from each of the cells.

The first configuration information may include at least one of: information on a secondary cell group, state information of each of secondary cells included in the secondary cell group, broadcast-related configuration information for the secondary cells, or access information for the terminal to access each of the secondary cells.

The state information may indicate one of an active state, an inactive state, a candidate state, or a configured state, the candidate state may indicate a state in which a secondary cell is capable of being transitioned to a primary cell, and the configured state may indicate a state in which the secondary cell is configured as the primary cell.

The broadcast-related configuration information may include at least one of: information indicating whether each of the secondary cells performs broadcasting, or a broadcast start time of a secondary cell determined to perform broadcasting among the secondary cells.

According to the present disclosure, a base station may receive a measurement report from a terminal. The base station may generate first configuration information for target cell selection by the terminal based on the measurement report. The first configuration information may include cell group configuration information and state information of each of secondary cells included in a cell group. The base station may transmit the first configuration information to the terminal. The terminal may perform access to a secondary cell according to the first configuration information. Alternatively, the terminal may determine whether to perform cell switching according to the first configuration information and may transmit, to the base station, a command instructing transition of one cell among existing secondary cells into a primary cell. Through the above-described procedures, service continuity can be improved in a communication environment in which cells are discontinuously formed due to an ultra-high frequency band. Through the above-described procedures, an outage rate caused by handover performed in a narrow beam service area can be reduced.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3A is a conceptual diagram illustrating exemplary embodiments of cells based on carrier aggregation.

FIG. 3B is a conceptual diagram illustrating exemplary embodiments of cells based on carrier aggregation.

FIG. 4 is a conceptual diagram illustrating exemplary embodiments of cells based on carrier aggregation in a dual connectivity environment.

FIG. 5 is a timing diagram illustrating exemplary embodiments of an SCC activation and deactivation procedure.

FIG. 6A is a timing diagram illustrating exemplary embodiments of a method of performing carrier aggregation when handover occurs.

FIG. 6B is a timing diagram illustrating exemplary embodiments of a method of performing carrier aggregation when handover occurs.

FIG. 7 is a conceptual diagram illustrating exemplary embodiments of terminal-centric cells.

FIG. 8 is a conceptual diagram illustrating exemplary embodiments of cell switching according to movement of a terminal.

FIG. 9A is a timing diagram illustrating exemplary embodiments of cell switching according to movement of a terminal.

FIG. 9B is a timing diagram illustrating exemplary embodiments of cell switching according to movement of a terminal.

FIG. 10 is a conceptual diagram illustrating exemplary embodiments of cell switching due to handover.

FIG. 11A is a timing diagram illustrating exemplary embodiments of cell switching due to handover.

FIG. 11B is a timing diagram illustrating exemplary embodiments of cell switching due to handover.

FIG. 11C is a timing diagram illustrating exemplary embodiments of cell switching due to handover.

FIG. 12 is a conceptual diagram illustrating exemplary embodiments of a method of operating cell groups.

FIG. 13A is a flowchart illustrating exemplary embodiments of a method of operating cell groups.

FIG. 13B is a flowchart illustrating exemplary embodiments of a method of operating cell groups.

FIG. 13C is a flowchart illustrating exemplary embodiments of a method of operating cell groups.

FIG. 14 is a sequence diagram illustrating exemplary embodiments of a neighboring cell measurement procedure.

FIG. 15 is a sequence diagram illustrating exemplary embodiments of a method of operating a primary cell and a secondary cell.

FIG. 16 is a conceptual diagram illustrating exemplary embodiments of a functional structure of a base station performing CA-based communication.

FIG. 17 is a conceptual diagram illustrating exemplary embodiments of logical functions of a base station performing CA-based communication.

FIG. 18 is a conceptual diagram illustrating exemplary embodiments of states of a secondary cell.

FIG. 19 is a flowchart illustrating exemplary embodiments of state transition of a secondary cell.

FIG. 20 is a sequence diagram illustrating exemplary embodiments of an access procedure for a secondary cell.

FIG. 21A is a sequence diagram illustrating exemplary embodiments of a primary cell change procedure.

FIG. 21B is a sequence diagram illustrating exemplary embodiments of a primary cell change procedure.

FIG. 22A is a sequence diagram illustrating exemplary embodiments of a terminal selection-based cell switching procedure.

FIG. 22B is a sequence diagram illustrating exemplary embodiments of a terminal selection-based cell switching procedure.

FIG. 23A is a sequence diagram illustrating exemplary embodiments of a terminal selection-based cell switching procedure.

FIG. 23B is a sequence diagram illustrating exemplary embodiments of a terminal selection-based cell switching procedure.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re) transmission’ may refer to ‘transmission’, ‘retransmission’, or ‘transmission and retransmission’, ‘(re) configuration’ may refer to ‘configuration’, ‘reconfiguration’, or ‘configuration and reconfiguration’, ‘(re) connection’ may refer to ‘connection’, ‘reconnection’, or ‘connection and reconnection’, and ‘(re) access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted.

A communication network (or communication system) to which exemplary embodiments according to the present disclosure are applied will be described. The communication network to which exemplary embodiments according to the present disclosure are applied is not limited to the content described below, and the exemplary embodiments according to the present disclosure can be applied to various communication networks. Here, the term ‘communication network’ may be used interchangeably with ‘communication system’. The communication network may refer to a wireless communication network, and the communication system may refer to a wireless communication system.

In the present disclosure, ‘configuration of an operation (e.g. transmission operation)’ may refer to signaling of configuration information (e.g. information elements, parameters) required for the operation and/or information indicating to perform the operation. ‘configuration of information elements (e.g. parameters)’ may refer to signaling of the information elements. In the present disclosure, signaling may be at least one of System Information (SI) signaling (e.g. transmission of System Information Block (SIB) and/or Master Information Block (MIB)), RRC signaling (e.g. transmission of RRC parameters and/or higher-layer parameters), MAC Control Element (CE) signaling, or PHY signaling (e.g. transmission of Downlink Control Information (DCI), Uplink Control Information (UCI), and/or Sidelink Control Information (SCI).

The names of frames proposed in the present disclosure may be generalized as a first frame, a second frame, a third frame, and the like. In the present disclosure, a transmission time may refer to a start time of frame transmission and/or an end time (e.g. completion time) of frame transmission, while a reception time may refer to a start time of frame reception and/or an end time (e.g. completion time) of frame reception. The term ‘time’ may be interpreted as a time point depending on a context.

In the present disclosure, a phrase including “when ˜” may be expressed as a phrase including “based on ˜” or a phrase including “in response to ˜”. In other words, a phrase including “when ˜” may be interpreted as being the same as or similar to a phrase including “based on ˜” or a phrase including “in response to ˜”.

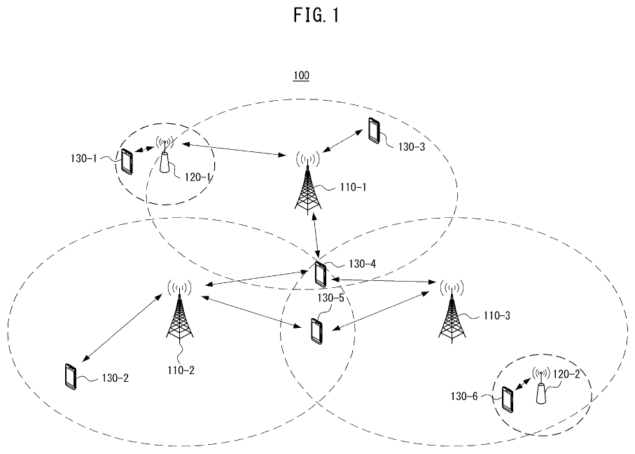

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g. a serving gateway (S-GW), a packet data network (PDN) gateway (P-GW), and a mobility management entity (MME)). When the communication system 100 is a 5G communication system (e.g. New Radio (NR) system), the core network may include an access and mobility management function (AMF), a user plane function (UPF), a session management function (SMF), and the like.

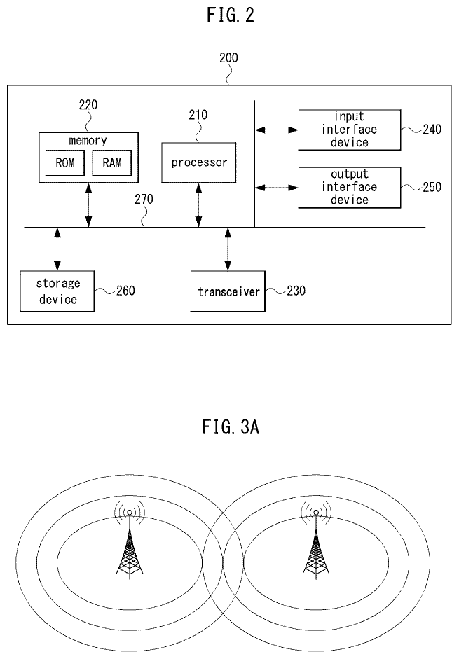

The plurality of communication nodes 110 to 130 may support communication protocols defined in the 3rd generation partnership project (3GPP) technical specifications (e.g. LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may have a structure below. FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multi-hop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g. single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e, the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, operation methods of a communication node in a communication network will be described. Even when a method (e.g. transmission or reception of a signal) to be performed at a first communication node among communication nodes is described, a corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

### [Need for a Terminal-Centric CA Operation Method]

An ultra-high frequency band provides a very wide bandwidth, and therefore a large amount of radio resources can be easily secured. However, due to strong straight-line propagation characteristics and severe propagation loss, formation of traditional cell coverage may be difficult. Accordingly, an ultra-high frequency band may be used primarily in limited environments such as in-device communication, peer-to-peer (P2P) communication, intra-data center connections, or wireless backhaul.

Multi-antenna-based beamforming technology may be introduced. Owing to the beamforming technology, efforts to use an ultra-high frequency band including a terahertz band for mobile communication may continue to expand. In mobile communication using an ultra-high frequency band, ultra-fine beamforming technology using a large-scale antenna array and multi-input multi-output (MIMO) technology based on multiple transmission and reception points (TRPs) may be applied. A radio access scheme may evolve from a conventional cell-centric radio access scheme to a beam-based user-centric radio access scheme.

The present disclosure proposes a carrier component (CC) group operation method that enables terminal-centric carrier aggregation (CA) operations based on cells formed through multiple beams. According to the present disclosure, even when a beam service area to which a terminal belongs changes due to a time difference between a control signal transmission/reception and a data transmission/reception, a change of the beam service area may be immediately reflected in a control signal transmission/reception procedure and a data transmission/reception procedure. By using CC groups adjusted for each UE, stable CA operations may be maintained despite frequent environmental changes occurring in narrow beam service areas formed by multiple TRPs.

The CC group operation method proposed in the present disclosure can effectively reduce outages caused by frequent movement between beam service areas, CC reconfiguration, or handover occurring in cells formed in an ultra-high frequency band (hereinafter referred to as ‘ultra-high frequency cells’). For example, in a dense urban environment, ultra-high frequency cells may be formed by a plurality of TRPs. The CC group operation method proposed in the present disclosure may maintain continuous service quality in a complex communication environment in which beam-formed cells are present.

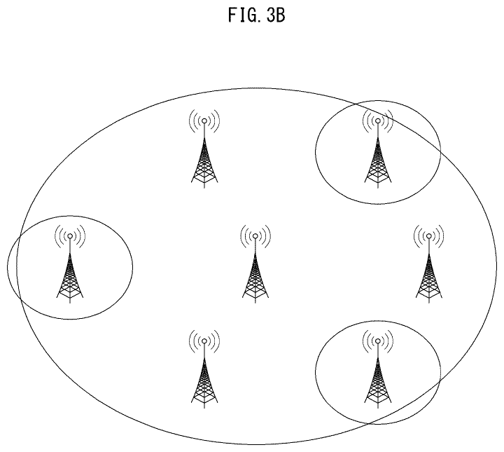

FIG. 3A and FIG. 3B are conceptual diagrams illustrating exemplary embodiments of cells based on carrier aggregation.

Referring to FIG. 3A, a base station may form cells based on carrier aggregation (CA). The base station may form a primary cell (PCell) through a primary component carrier (PCC) used for CA. The base station may form secondary cells (SCells) through secondary component carriers (SCCs) used for CA. A size of a cell formed by a CC may vary depending on a frequency of the CC.

Referring to FIG. 3B, the base station with split functions may include radio units (RUs) and a central unit (CU). A plurality of RUs may be distributed around the CU. Each of the RUs may form a cell having a different coverage range and size. Cells having different sizes may be formed by one base station.

As CCs used when CA is performed, a PCC and SCC(s) may be considered. The PCC may be a CC primarily used by a terminal. The PCC may be configured for each terminal by the base station. The base station may transmit control information to the terminal through the PCC. The base station may form the PCell through the PCC. Regardless of whether other CCs are configured, the terminal may always perform communication with the base station through the PCell.

When an amount of data to be transmitted by the terminal is not large, the terminal may perform communication with the base station only through transmission and reception using the PCell. When an amount of data transmitted and received between the terminal and the base station rapidly increases, the base station may additionally activate one or more SCCs having a wide bandwidth for high-speed transmission. The base station may activate SCC(s) only when necessary, thereby minimizing power consumption of the terminal. A procedure of changing the PCC used by the terminal to another PCC may be possible only through handover.

A PCC may correspond to a PCell, and an SCC may correspond to an SCell. A PCC used for downlink communication may be determined. The PCell may be associated with the terminal. When a PCC used for downlink communication (hereinafter referred to as ‘DL PCC’) is determined, a PCC used for uplink communication (i.e. ‘UL PCC’) may also be determined as the same PCC as the DL PCC according to a configuration included in system information block 2 (SIB2) received by the terminal through downlink. Referring to Table 1, functions that are performed by the PCell corresponding to the PCC and the SCell corresponding to the SCC may be identified.

TABLE 1

| | PCell | SCell |
|---|---|---|
| Random access | ◯ | X |
| PUCCH transmission | ◯ | X |
| RLF monitoring | ◯ | X |
| SPS transmission | ◯ | X |
| Uplink timing adjustment | ◯ | X |
| Monitoring for broadcast signaling of system information | ◯ | X |
| PDCCH/PDSCH/PUSCH | ◯ | X |

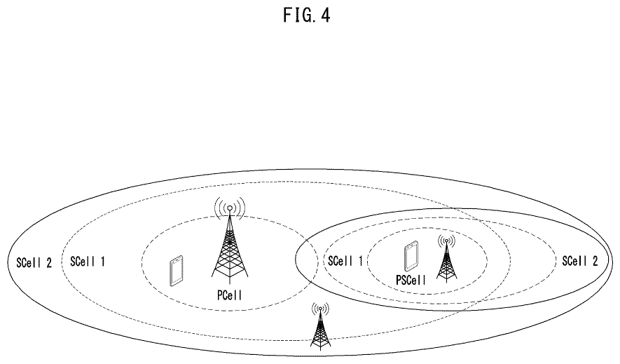

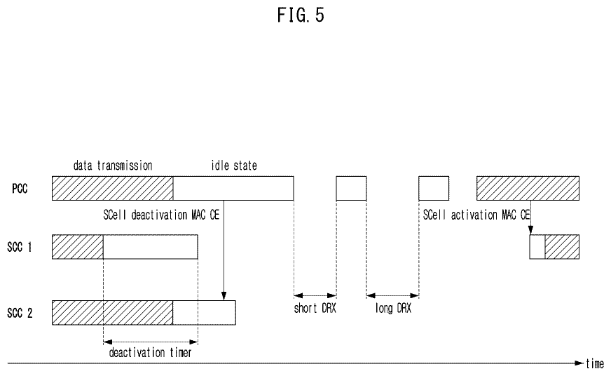

FIG. 4 is a conceptual diagram illustrating exemplary embodiments of cells based on carrier aggregation in a dual connectivity environment.

Referring to FIG. 4, a base station (or node) may configure one PCC for a terminal through an initial access procedure. The base station may determine a PCell corresponding to the configured PCC. The base station may configure SCells associated with the PCell through CA. Since the environment is a dual connectivity (DC) environment, a base station other than the base station that formed the PCell may configure a primary secondary cell (PSCell) for the terminal. The base station other than the base station that formed the PCell may configure SCells associated with the PSCell through CA. As a result, a set of cells used by the terminal may be hierarchically configured. A set of cells including SCells added through CA centered on the PCell, the PSCell formed through dual connectivity by a base station other than the base station that formed the PCell, and a set of cells including SCells added through CA centered on the PSCell may be configured for the terminal. The above-described cell sets or cells may be associated with one PCell.

A set of cells belonging to the same node (e.g. master node) as the PCell and providing services to the terminal may be referred to as a master cell group (MCG). A set of cells belonging to a node different from the PCell (e.g. secondary node) and providing services to the terminal may be referred to as a secondary cell group (SCG). The MCG and the SCG may be configured centered on the PCell and the PSCell, respectively. In FIG. 4, it can be identified that the MCG and the SCG are combined through CA and DC.

In the above-described structure in which a set of cells associated with one PCell is configured, when the PCell is changed for a certain reason (e.g. handover, radio link failure (RLF) recovery, beam pairing change, or beam failure recovery), the previous PSCell and SCells associated with the PCell and the previous SCells associated with the PSCell may not be maintained. In other words, when the PCell is changed, the entire sets of cells and cells configured through CA and DC may need to be reconfigured.

FIG. 5 is a timing diagram illustrating exemplary embodiments of an SCC activation and deactivation procedure.

Referring to FIG. 5, SCCs activated or deactivated by medium access control (MAC)-control elements (CEs) transmitted and received in a PCell over time may be identified. A base station may transmit an SCC activation MAC-CE or an SCC deactivation MAC-CE to a terminal through the PCell. The terminal may receive the SCC activation MAC-CE or the SCC deactivation MAC-CE from the base station through the PCell.

Activation of CA may be determined by an amount of data waiting in a buffer of the terminal in uplink and downlink. The base station may perform resource allocation for uplink and downlink communication based on a buffer status report (BSR). In order for the base station to provide resources for uplink communication, the base station may need to know an amount of data generated by an application of the terminal. The terminal may report a BSR including buffer status information to the base station. The buffer status may be a buffer status of an uplink buffer of a logical channel group (LCG) including logical channels. Each radio bearer (RB) may be mapped to an LCG based on a quality of service (QoS) profile (e.g. QoS class identifier (QCI)) of the RB. The resource allocation for uplink communication performed by the base station may be performed based on QoS profiles (e.g. QCIs) of the RBs and the reported buffer status.

A trigger for transmitting a BSR by the terminal may be as follows. When new data enters the uplink buffer, the terminal may transmit a BSR to the base station. When high-priority data enters the uplink buffer, the terminal may transmit a BSR to the base station. In another example, the terminal may maintain a periodic timer periodicBSRTimer so that the base station identifies a latest buffer status of the uplink buffer. While the periodic timer is running, the terminal may not transmit a BSR. When the periodic timer expires, the terminal may transmit a BSR to the base station.

An SCC may be activated through an SCC activation MAC-CE transmitted from the base station through a PCC. An SCC may be deactivated through an SCC deactivation MAC-CE transmitted from the base station through the PCC. Alternatively, an SCC may be deactivated upon expiration of a deactivation timer configured in advance through radio resource control (RRC) signaling.

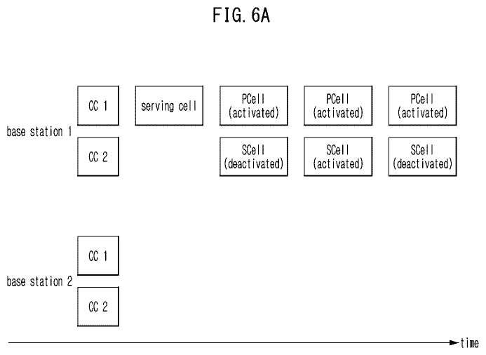

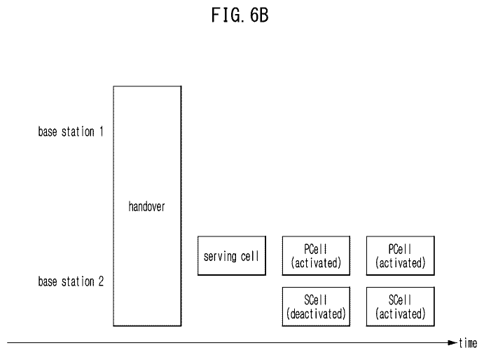

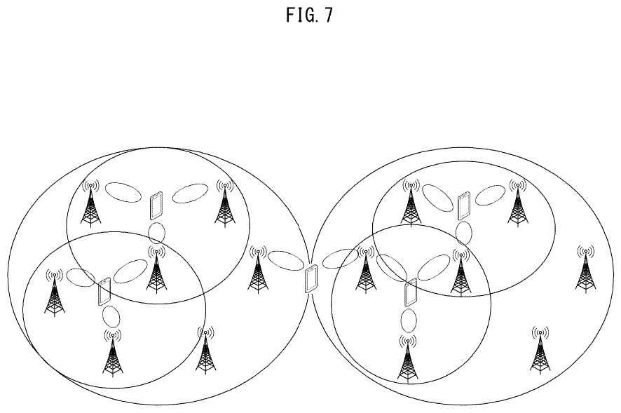

FIG. 6A and FIG. 6B are timing diagrams illustrating exemplary embodiments of a method of performing carrier aggregation when handover occurs.

Referring to FIG. 6A and FIG. 6B, a terminal performing CA-based communication may perform handover in a multi-TRP-based ultra-high frequency band environment. FIG. 6A shows a situation in which a PCell and SCells are operated when the terminal needs to perform handover.

When multi-TRP-based beamforming is performed in an ultra-high frequency band, a beam service area may be narrow. Cells formed by multi-TRP-based beamforming in an ultra-high frequency band may be discontinuous. When the terminal moves in a communication environment in which the above-described beam service areas exist, the terminal may have difficulty belonging to one cell. Accordingly, handover of the terminal may occur frequently. When the terminal performs handover, existing serving cells (i.e. PCell and SCells) may be collectively released. A PCell changed due to handover and SCells associated with the changed PCell may be configured again for the terminal that performed handover to a new cell (or a new base station).

In the above-described cell structure, an SCell addition/release procedure may be repeatedly performed according to movement of the terminal. When the SCell addition/release procedure is repeated, provision of low-latency and high-capacity services in the ultra-high frequency band and provision of continuous services may not be achieved. In CA-based communication, most data may be transmitted and received through SCells. When the terminal performs handover, the SCells may not be maintained. When the SCells are not maintained, transmission delay may increase, and a possibility of service interruption may increase. Limitations of the conventional CA operation method may be identified through FIG. 6A and FIG. 6B.

FIG. 7 is a conceptual diagram illustrating exemplary embodiments of terminal-centric cells.

Referring to FIG. 7, a terminal-centric cell may include a plurality of TRPs. The plurality of TRPs may be connected to each other through an ideal backhaul link or a non-ideal backhaul link. A narrow-beam-based cell configuration scenario may not be limited to a cloud radio access network (CRAN) structure and an ideal backhaul. The ideal backhaul may refer to a backhaul in which almost no delay occurs even when an amount of data is infinite. The narrow-beam-based cell configuration scenario may be expanded to a plurality of TRPs that cooperate through centralized control.

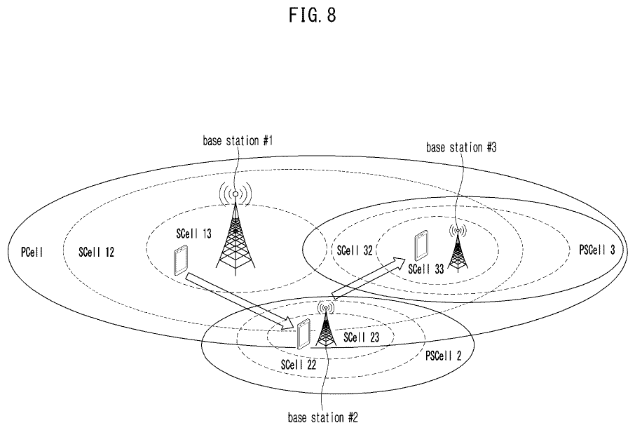

FIG. 8 is a conceptual diagram illustrating exemplary embodiments of cell switching according to movement of a terminal.

Referring to FIG. 8, a terminal may access a base station #1. The terminal may perform CA configuration according to a policy of the base station #1. SCC(s) configured through CA configuration may be allocated to the terminal. The terminal may perform communication with the base station #1 through SCell(s) associated with the allocated SCC(s) (e.g. SCell 12, SCell 13).

The terminal may enter an area (i.e. cell overlap area) in which a cell formed by the base station #1 overlaps with a cell formed by a base station other than the base station #1 (e.g. base station #2 and base station #3). When the terminal enters the cell overlap area, the terminal may select whether to maintain an existing CC group. For example, when the terminal is in a cell formed by the base station #1, a CC group configured for the terminal may include a PCell, SCell 12, and SCell 13. When the terminal enters a cell formed by the base station #2, the terminal may determine whether to maintain the cell group including the PCell, SCell 12, and SCell 13.

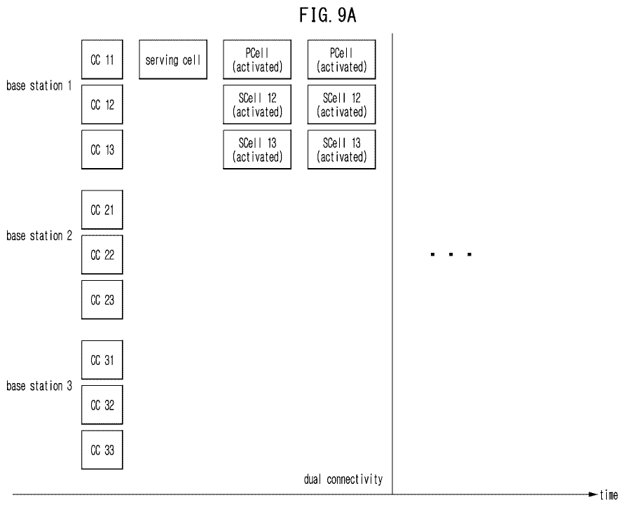

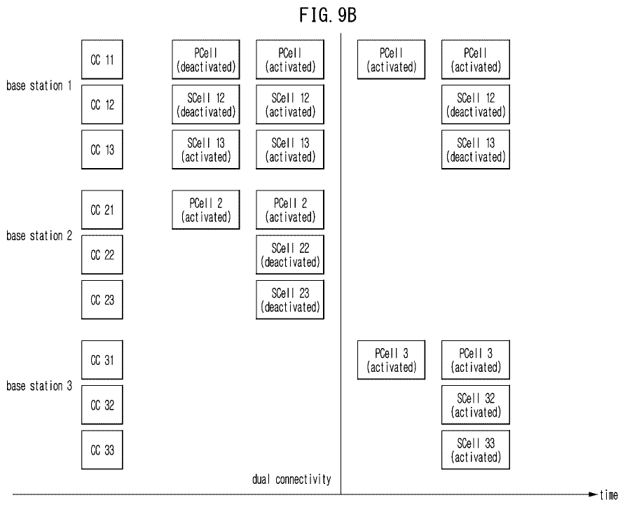

FIG. 9A and FIG. 9B are timing diagrams illustrating exemplary embodiments of cell switching according to movement of a terminal. The exemplary embodiments according to FIG. 9A and FIG. 9B may be the same as the exemplary embodiments according to FIG. 8.

Referring to FIG. 9A, each of base stations (e.g. base station #1, base station #2, and base station #3) may operate three CCs. CC 11 of the base station #1 may serve as a serving cell. Before performing dual connectivity with the base station #2, the terminal may perform communication with the base station #1 through CC 11, CC 12, and CC 13. When the terminal performs communication with the base station #1, CC 11 may correspond to a PCell, CC 12 may correspond to SCell 12, and CC 13 may correspond to SCell 13.

Referring to FIG. 9B, the terminal may enter a cell formed by the base station #2 according to movement of the terminal. The terminal may be connected to the base station #1 and the base station #2 through dual connectivity.

When the terminal enters the cell formed by the base station #2, PSCell 2 of the base station #2 may be activated. SCell 12 and SCell 13 may be deactivated based on activation of PSCell 2. However, based on an increase in an amount of data transmitted and received between the terminal and base stations (e.g. base station #1 and base station #2), SCell 12 and SCell 13 that were deactivated may be activated again. Deactivation of SCell 22 and SCell 23 of the base station #2 and activation of SCell 12 and SCell 13 may be because a quality of communication through SCell 12 and SCell 13 is better than a quality of communication through SCell 22 and SCell 23. In other words, even when the terminal enters the area of the base station #2, the terminal may maintain existing SCells. CC 21 may correspond to PSCell 2. CC 22 may correspond to SCell 22. CC 23 may correspond to SCell 23. The terminal may enter a cell formed by the base station #3 according to movement of the terminal. When the terminal enters the cell formed by the base station #3, PSCell 3 of the base station #3 may be activated.

The terminal may enter the cell formed by the base station #3 according to movement of the terminal. The terminal may be connected to the base station #1 and the base station #3 through dual connectivity. Based on an increase in an amount of data transmitted and received between the terminal and the base station #3, SCell 32 and SCell 33 may be activated. Deactivation of SCell 12 and SCell 13 and activation of SCell 32 and SCell 33 may be because a quality of communication through SCell 32 and SCell 33 is better than a quality of communication through SCell 12 and SCell 13. CC 31 may correspond to PSCell 3. CC 32 may correspond to SCell 32. CC 33 may correspond to SCell 33.

The terminal may maintain SCells belonging to a cell group including an existing PCell according to movement of the terminal. Alternatively, the terminal may deactivate SCells belonging to the cell group including the existing PCell according to movement of the terminal. After deactivating the SCells belonging to the cell group including the existing PCell, the terminal may perform communication through SCells belonging to a cell group including a newly activated PSCell.

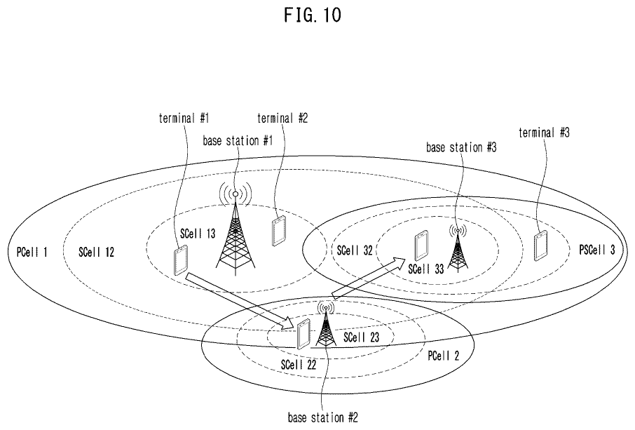

FIG. 10 is a conceptual diagram illustrating exemplary embodiments of cell switching due to handover.

Referring to FIG. 10, a terminal may perform CA-based communication with a base station #1. The terminal may perform communication with the base station #1 through PCell 1, SCell 12, and SCell 13. The terminal may enter an area of a base station #2 according to movement of the terminal. When the terminal enters the area of the base station #2, the terminal may perform handover. The terminal may perform PCell switching through handover. Through handover, a primary cell of the terminal may be switched from PCell 1 to PCell 2. PCell 2 may be a primary cell formed by the base station #2. When the terminal performs handover, transmission and reception of data may be sufficiently performed only through PCell 1. When transmission and reception of data are sufficiently performed only through PCell 1, SCell 12 and SCell 13 may be deactivated before handover. When SCell 12 and SCell 13 are deactivated before handover, service continuity may be ensured even when handover occurs. When transmission and reception of data are not sufficiently performed only through PCell 1, the base station #1 may change resource allocation for another terminal (e.g. terminal #2). With resources secured through change of resource allocation, the base station #1 may secure resources of PCell 1 for the terminal #1.

The terminal that completed handover may perform communication with the base station #2 through PCell 2. The terminal that completed handover may release existing SCells (e.g. SCell 12 and SCell 13). The terminal that completed handover may perform communication with the base station #2 through SCell 22 and SCell 23.

The terminal may enter an area of a base station #3. Through handover, the primary cell may be switched from PCell 2 to PCell 1. Through handover, existing SCells (e.g. SCell 22 and SCell 23) may be released. The terminal may be connected to the base station #1 and the base station #3 through dual connectivity. The terminal may perform communication with the base station #3 through PSCell 3, SCell 32, and SCell 33. The terminal may release SCell 12 and SCell 13 which are secondary cells of the base station #1.

In other words, when the terminal enters an area of another base station, the terminal may select one of the following two schemes. The terminal may maintain existing secondary cells. Alternatively, the terminal may release existing secondary cells. The terminal that releases existing secondary cells may switch its secondary cells to secondary cells formed by another base station.

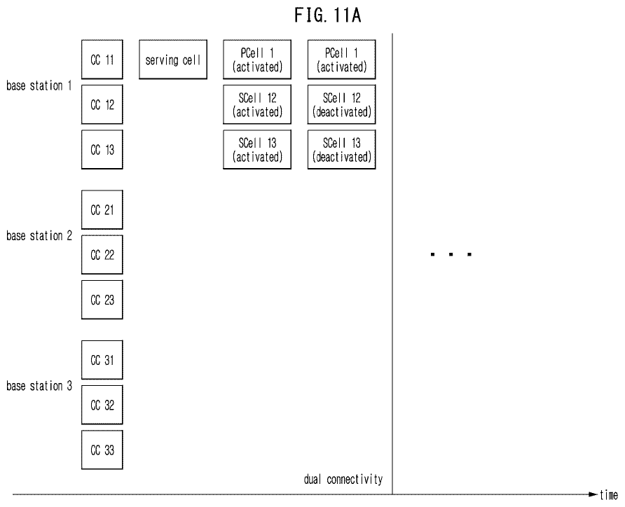

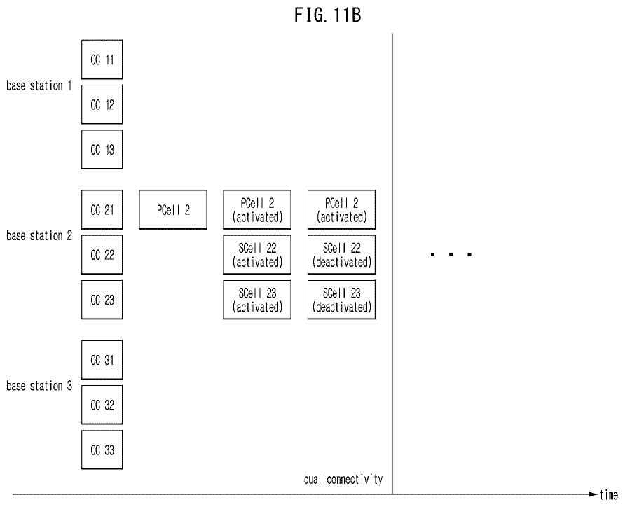

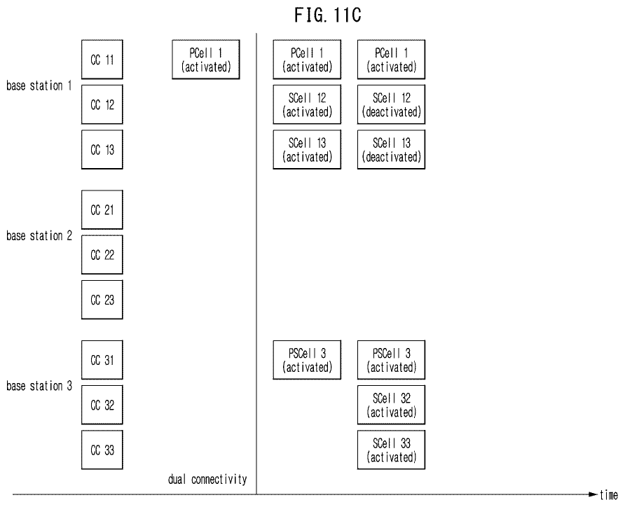

FIG. 11A to FIG. 11C are timing diagrams illustrating exemplary embodiments of cell switching due to handover. The exemplary embodiments according to FIG. 11A to FIG. 11C may be the same as the exemplary embodiments according to FIG. 10.

Referring to FIG. 11A, a terminal may perform communication with a base station #1. The terminal may perform communication with the base station #1 through PCell 1, SCell 12, and SCell 13. The terminal may perform handover to a base station #2. Before performing handover, the terminal may deactivate existing secondary cells (e.g. SCell 12 and SCell 13).

Referring to FIG. 11B, the terminal may switch a primary cell from PCell 1 to PCell 2 through handover. The terminal may perform communication with the base station #2 through CA. The terminal may perform communication with the base station #2 through PCell 2, SCell 22, and SCell 23.

Referring to FIG. 11C, the terminal may perform handover to the base station #1 according to movement of the terminal. After performing handover, the terminal may perform communication with the base station #1 through PCell 1. The terminal may perform communication with the base station #1 and the base station #3 through dual connectivity. The terminal may perform communication with the base station #3 through PSCell 3, SCell 32, and SCell 33. Activation of SCell 32 and SCell 33 and deactivation of SCell 12 and SCell 13 may be because a quality of communication through SCell 32 and SCell 33 is better than a quality of communication through SCell 12 and SCell 13.

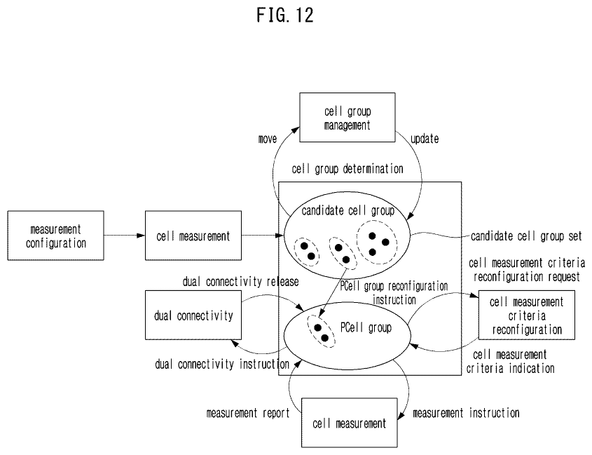

FIG. 12 is a conceptual diagram illustrating exemplary embodiments of a method of operating cell groups.

Referring to FIG. 12, a terminal may perform measurement on neighboring cells according to measurement configuration information received from a base station. The terminal may transmit measurement results obtained through measurement to the base station (e.g. central unit (CU)). The base station may determine at least one of maintenance of a cell group, necessity of cell group reconfiguration, necessity of handover, or necessity of PCell reconfiguration based on the received measurement results.

The base station may transmit a cell group reconfiguration instruction to the terminal through an RRC reconfiguration message. The terminal may configure a new cell group according to the cell group reconfiguration instruction. That is, a new PCell and new SCells may be configured for the terminal. The terminal may perform activation or deactivation (or release) of SCells according to the cell group reconfiguration instruction. According to the cell group reconfiguration instruction, new SCells may be configured for the terminal. The terminal may update a candidate cell group according to the cell group reconfiguration instruction. The terminal may report information on the changed cell group to the base station through an RRC reconfiguration complete message.

The base station may determine a transmission priority of each cell based on information on the changed (or latest cell) group received from the terminal. The base station may allocate resources to each CC based on the transmission priority of each cell.

When the base station determines that existing measurement criteria (e.g. a measurement periodicity) are no longer suitable due to movement of the terminal, the base station may determine that reconfiguration of cell measurement criteria is required. When a candidate cell group is changed, the base station may determine that reconfiguration of cell measurement criteria is required. The cell measurement criteria may indicate at least one of a measurement target, a measurement scheme, a measurement periodicity, or measurement resources (e.g. CSI-RS resource(s) or SSB resource(s)). The base station may indicate the changed cell measurement criteria to the terminal. In another example, the terminal may receive a cell measurement criteria reconfiguration request from the base station.

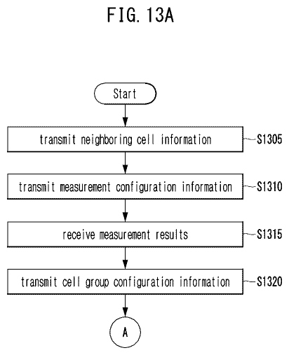

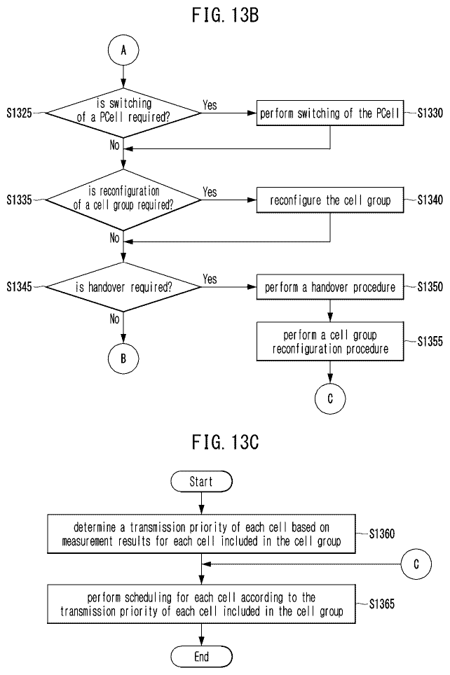

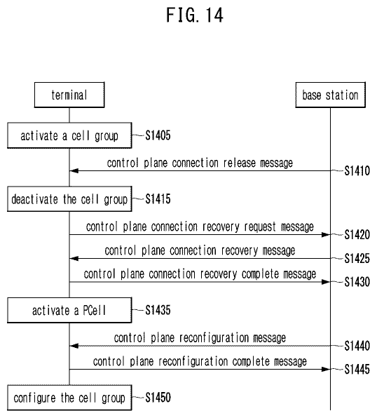

FIG. 13A to FIG. 13C are flowcharts illustrating exemplary embodiments of a method of operating cell groups.

Referring to FIG. 13A, a base station may transmit neighboring cell information to a terminal (S1305). The base station may transmit measurement configuration information to the terminal (S1310). The terminal may perform measurement on each neighboring cell obtained through the neighboring cell information based on the measurement configuration information (S1315). The terminal may transmit measurement results for each neighboring cell (e.g. channel quality indicator (CQI)) to the base station. The base station may generate cell group configuration information based on the measurement results. The base station may transmit the cell group configuration information to the terminal (S1320). A cell group may be configured for the terminal through the cell group configuration information.

Referring to FIG. 13B, the base station may determine whether switching of a primary cell is required based on the measurement results (S1325). For example, when a quality of a primary cell included in the cell group currently configured for the terminal rapidly degrades, the base station may determine switching of the primary cell. When the base station determines that switching of the primary cell is required, the base station may determine switching of the primary cell (S1330).

The base station may determine whether reconfiguration of the cell group is required (S1335). Reconfiguration of the cell group may refer to at least one of activation of a new secondary cell that is not included in the existing cell group, deactivation or release of a secondary cell included in the existing cell group, or configuration indicating whether each secondary cell included in the existing cell group performs broadcasting. When the base station determines that reconfiguration of the cell group is required, the base station may reconfigure the cell group (S1340).

The base station may determine whether handover is required (S1345). When the base station determines that handover is required, the base station may perform a handover procedure (S1350). According to a result of handover, the base station may perform a cell group reconfiguration procedure (e.g. release/addition of a primary cell included in the cell group) (S1355). Referring to FIG. 13C, after performing the cell group reconfiguration procedure, the base station may perform data scheduling for each cell according to a transmission priority of each cell included in the cell group (S1365). The data scheduling may refer to selecting a cell through which data is transmitted or determining an amount of data allocated to each cell. When the base station does not determine handover, the base station may determine a transmission priority of each cell based on measurement results for each cell included in the cell group (S1360). Determining a transmission priority of each cell may refer to determining which cell is preferentially allocated with resources used for transmission.

FIG. 14 is a sequence diagram illustrating exemplary embodiments of a neighboring cell measurement procedure.

Referring to FIG. 14, in a situation in which a control plane connection between a terminal and a base station is established, a cell group configured for the terminal may be activated (S1405). The terminal may receive a control plane connection release message, measurement configuration information, and a measurement instruction from the base station (S1410). Upon receiving the measurement instruction, the terminal may periodically perform measurement on neighboring cells according to the measurement configuration information. When the control plane connection release message is received by the terminal, the control plane connection between the terminal and the base station may be released. When the control plane connection is released, the cell group configured for the terminal may be deactivated (S1415). When the control plane connection is released, the terminal may restrict transmission and reception of signals to reduce battery consumption.

The terminal may transmit a control plane connection recovery request message to the base station (S1420). After receiving the control plane connection recovery request, the base station may transmit a control plane connection recovery message including a control plane connection recovery instruction and a measurement result request to the terminal (S1425). When the control plane connection recovery instruction is received by the terminal, the control plane connection between the terminal and the base station may be recovered. The terminal may transmit measurement results to the base station according to the received measurement result request. When the control plane connection is recovered, the terminal may transmit a control plane connection recovery complete message to the base station (S1430).

When the control plane connection recovery is completed, the terminal may activate a primary cell (S1435). The base station may transmit a control plane reconfiguration message and a cell group reconfiguration message (S1440). When the control plane reconfiguration message is received by the terminal, the control plane between the terminal and the base station may be reconfigured. After completing cell group reconfiguration, the terminal may transmit a cell group reconfiguration complete message to the base station (S1445). The terminal may reconfigure the cell group according to the cell group reconfiguration message (S1450).

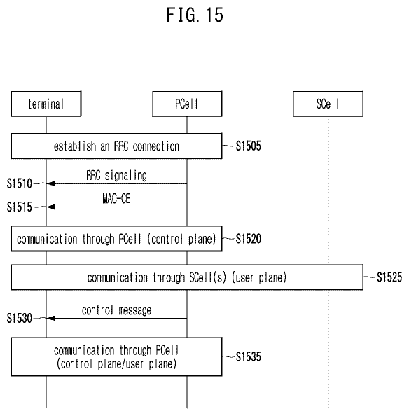

FIG. 15 is a sequence diagram illustrating exemplary embodiments of a method of operating a primary cell and a secondary cell.

Referring to FIG. 15, after completing initial access, a terminal may establish an RRC connection with a base station (S1505). The terminal may be connected to the base station through a PCell. The terminal may receive RRC signaling from the base station through the PCell (S1510). The terminal may receive a cell activation MAC-CE or a cell deactivation MAC-CE from the base station through the PCell (S1515). The terminal may perform communication with the base station on a control plane through the PCell (S1520). The terminal may perform communication with the base station on a user plane through SCell(s) (S1525). The terminal may receive a control message from the base station through the PCell (S1530). The control message may include cell group configuration information. Addition or release of SCell(s) may be performed through the cell group configuration information. The terminal may perform communication with the network through the PCell (S1535). Communication through the PCell may be performed on the control plane or on the user plane.

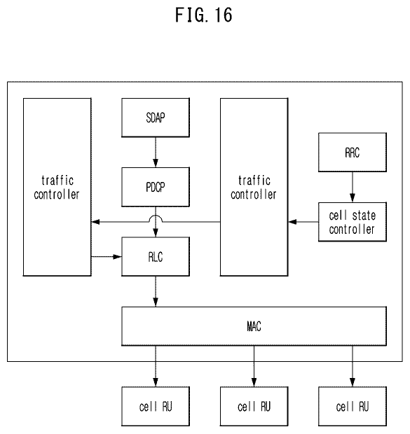

FIG. 16 is a conceptual diagram illustrating exemplary embodiments of a functional structure of a base station performing CA-based communication.

Referring to FIG. 16, an RRC layer of a base station may generate control signaling for performing addition or release of cell(s), activation or deactivation of cell(s), and change of a primary cell. For example, an RRC reconfiguration message for addition of secondary cell(s) may be generated in the RRC layer of the base station. A cell state controller may be a module that determines a state of each of cells according to an instruction of the RRC layer. The instruction of the RRC layer may instruct activation or deactivation of a cell (e.g. a primary cell or a secondary cell), release of a cell, or management of a cell in a candidate state. The cell state controller may manage a state of each of cells in real time in a CA environment.

A traffic controller may determine which data is to be transmitted to the primary cell and which data is to be transmitted to which secondary cell based on an amount of data required for each of QoS flows. A scheduler may perform a role of allocating resources for cells (e.g. the primary cell and secondary cells). A MAC layer may perform uplink transmission or downlink transmission according to an instruction of the scheduler. A cell RU may be an RF module to which each of cells is physically mapped. The cell RU may perform a role of converting data transmitted by the MAC layer into a wireless signal and transmitting the wireless signal.

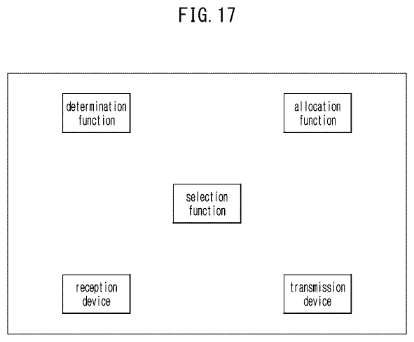

FIG. 17 is a conceptual diagram illustrating exemplary embodiments of logical functions of a base station performing CA-based communication.

Referring to FIG. 17, a base station may perform a determination function. The base station may determine a cell group based on capability information of a terminal. Determination of the cell group may refer to determining which CC is to be configured for the terminal. In other words, determination of the cell group may refer to at least one of determination of addition or deletion of a secondary cell or determination of whether to change a primary cell. The capability information of the terminal may include a combination of CCs that the terminal supports.

The base station may perform an allocation function. The base station may allocate resources to each of cells included in the cell group. Allocation of resources for each of cells by the base station may refer to configuring DL or UL BWPs included in a CC associated with each of cells. The base station may perform a selection function. The base station may determine through which cell transmission is to be preferentially performed when multiple cells are configured for the terminal.

A transmission device and a reception device may refer to an RF chain corresponding to each of cells. Transmission and reception may be performed through the transmission device and the reception device. The transmission device and the reception device may be responsible for transmission and reception of actual physical signals.

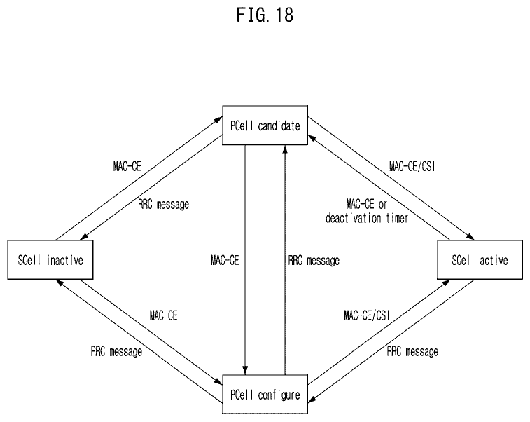

FIG. 18 is a conceptual diagram illustrating exemplary embodiments of states of a secondary cell.

Referring to FIG. 18, a cell may have one of four states. The four states may include a PCell candidate state, an SCell active state, an SCell inactive state, and a PCell configured state. In a secondary cell in the SCell inactive state, a sounding reference signal (SRS), channel state information (CSI) report, UL-shared channel (UL-SCH), random access channel (RACH), physical downlink control channel (PDCCH), and physical uplink control channel (PUCCH) may not be transmitted or received. A secondary cell in the SCell inactive state may enter the SCell active state when an SCell activation MAC CE is received by a terminal.

In a secondary cell in the SCell active state, a CSI report, CSI-RS, PDCCH, and PUCCH may be transmitted or received. The CSI report may include measurement results for CSI-RS received in the secondary cell. A secondary cell in the SCell active state may enter the SCell inactive state according to reception of an SCell deactivation MAC CE or expiration of a deactivation timer.

In a secondary cell in the PCell candidate state, a CSI report and CSI-RS may be transmitted or received. However, control signals (e.g. PDCCH) may not be transmitted or received in the secondary cell in the PCell candidate state. The secondary cell in the PCell candidate state may be a candidate that can be transitioned to a PCell later. In other words, the secondary cell in the PCell candidate state may be a state prepared in advance to be rapidly transitioned to PCell.

In a cell in the PCell configured state (i.e. primary cell), an SRS, CSI report, CSI-RS, UL-SCH, RACH, PDCCH, and PUCCH may be transmitted or received.

PCell switching may include the following three cases. First, SCells may be maintained and only PCell may be switched. Second, the PCell and SCells may be switched together. Third, when a quality of a certain SCell becomes good according to movement of the terminal, the certain SCell may perform a role of PCell. Accordingly, in a CA environment, an SCell may be transitioned to a PCell. Conventionally, since a PCell can be switched only through handover, delay may be large. Accordingly, switching of an SCell to a PCell may be possible only through handover. However, when a secondary cell in the PCell candidate state exists, the secondary cell may be immediately transitioned to a PCell by selection of the terminal without large delay.

The terminal may perform handover to another base station (e.g. a target base station) other than an existing base station. When secondary cells configured for the terminal while being connected with the existing base station overlap with secondary cells associated with the target base station, the overlapping secondary cells may be maintained even after handover. By including the secondary cells configured for the terminal while being connected with the existing base station in a handover message transmitted to the target base station, the terminal may maintain service continuity without additional reconfiguration of secondary cells.

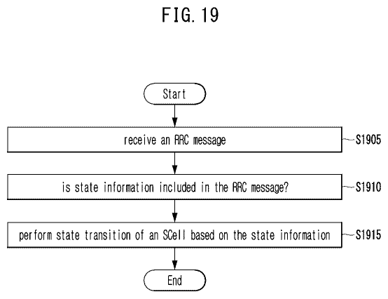

FIG. 19 is a flowchart illustrating exemplary embodiments of state transition of a secondary cell.

Referring to FIG. 19, a terminal may receive an RRC message (S1905). The terminal may check whether the RRC message includes state information of each of cells configured for the terminal (S1910). The state information may indicate one of four states according to the exemplary embodiments illustrated in FIG. 18. When state information of each of cells configured for the terminal is included in the RRC message, the terminal may perform state transition for each of secondary cells according to the state information (S1915).

According to the state information included in the RRC message, a secondary cell configured for the terminal may maintain an active state. According to the state information included in the RRC message, a secondary cell configured for the terminal may enter an inactive state. According to the state information included in the RRC message, a secondary cell configured for the terminal may enter the PCell candidate state. Since a BWP included in a secondary cell is in a dormant state, the secondary cell may be regarded as being in an inactive state. According to the state information included in the RRC message, a secondary cell in the PCell candidate state may be transitioned to a primary cell.

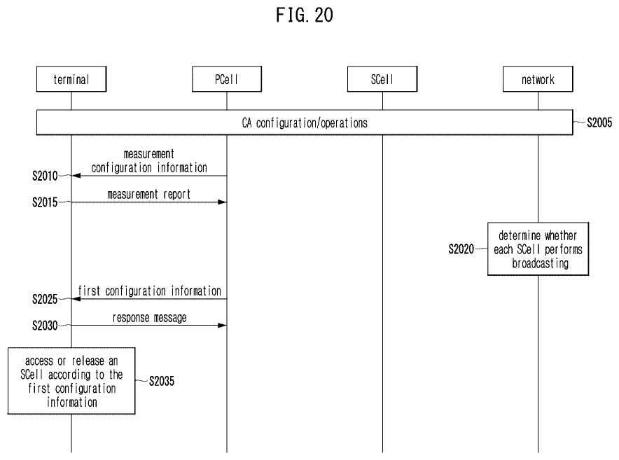

FIG. 20 is a sequence diagram illustrating exemplary embodiments of an access procedure for a secondary cell.

Referring to FIG. 20, a terminal may perform a CA operation according to CA configuration received from a network (S2005). For the terminal performing the CA operation according to the CA configuration, a primary cell (PCell) and secondary cells may be configured. The network may transmit measurement configuration information to the terminal based on capability information of the terminal received through the PCell (S2010). The capability information of the terminal may include at least one of whether dual connectivity is supported, supported frequency bands, or a number of supported secondary cells. The terminal may perform measurement on cells according to the measurement configuration information. After completing measurement, the terminal may report measurement results (or measurement report) to the network (S2015).

The network may change resource allocation for each of cells configured for the terminal for data distribution based on the measurement results. The network may determine which secondary cell(s) among the secondary cells configured for the terminal are to perform broadcasting (e.g. SSB broadcasting) based on the measurement result (S2020). In other words, the network may determine secondary cell(s) that do not perform broadcasting among the secondary cells configured for the terminal. The network may determine secondary cell(s) that perform broadcasting among the secondary cells configured for the terminal. For a secondary cell determined to perform broadcasting, the network may set a broadcast start time. The broadcast start time may be the same as a time when the secondary cell is configured for the terminal or may be a time when the secondary cell is activated after the secondary cell is configured for the terminal. Information indicating whether the secondary cell performs broadcasting and information of the broadcast start time may be collectively referred to as ‘broadcast-related configuration information’. The broadcast-related configuration information may be transmitted to the terminal at a time when a secondary cell activation command is transmitted. The broadcast-related configuration information may be transmitted to the terminal through system information, terminal-specific RRC signaling, MAC CE, or DCI.

The network may generate access information for accessing secondary cells. The network may transmit first configuration information to the terminal (S2025). The first configuration information may be transmitted through an RRC reconfiguration message. The first configuration information may include at least one of information indicating whether broadcasting is performed by each of the secondary cells configured for the terminal or the access information for accessing secondary cells. An SCell determined not to perform broadcasting may not perform broadcasting.

The terminal may transmit a response message for the received first configuration information (S2030). The terminal may perform access to a secondary cell according to the first configuration information (S2035). Alternatively, the terminal may release a secondary cell according to the first configuration information (S2035).

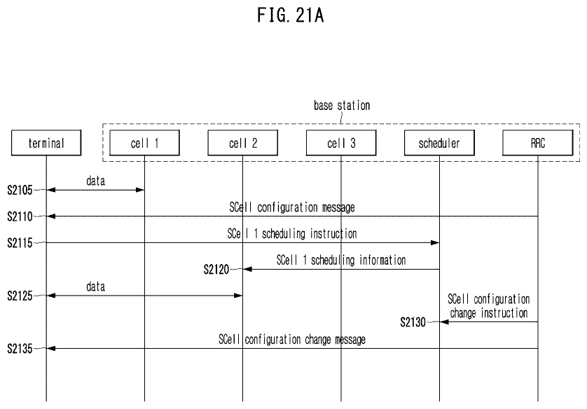

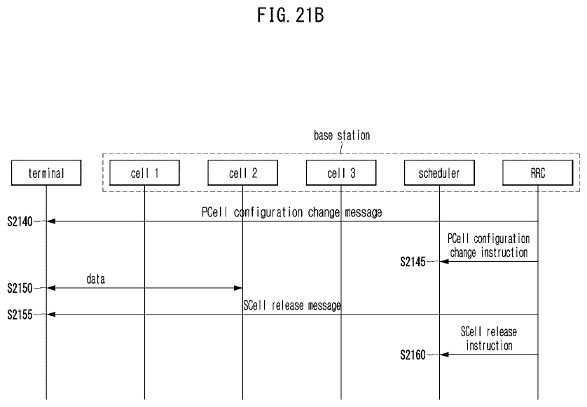

FIG. 21A and FIG. 21B are sequence diagrams illustrating exemplary embodiments of a primary cell change procedure.

Referring to FIG. 21A, a terminal may transmit and receive data with a base station through cell 1, which is a PCell (S2105). The terminal may enter an area of cell 2. The terminal that enters the area of cell 2 may receive SCell configuration information from the base station (S2110). According to the SCell configuration information, cell 2 may be configured as SCell 1. The terminal may transmit an SCell 1 scheduling instruction to a scheduler of the base station (S2115). According to the SCell 1 scheduling instruction, resources may be allocated to cell 2 by the scheduler. The scheduler may transmit SCell 1 scheduling information to SCell 1 (S2120). The terminal may transmit and receive data with the base station through SCell 1 (S2125).

The terminal may enter an area of cell 3. The terminal that enters the area of cell 3 may receive an SCell configuration change message from the base station (S2135). An RRC layer of the base station may transmit an SCell configuration change instruction to the scheduler (S2130). According to the SCell configuration change message, a secondary cell configured for the terminal may be changed to cell 3. Cell 3 may be SCell 2.

Referring to FIG. 21B, the terminal may leave an area of an existing PCell (e.g. cell 1). A radio environment provided by SCell 2 for the terminal may be the best. The RRC layer of the base station may transmit a PCell configuration change message to the terminal (S2140). The RRC layer may transmit a PCell configuration change instruction to the scheduler (S2145). According to the PCell change message, cell 3 may be transitioned to a PCell. The terminal may transmit and receive data and control signals with the base station through cell 3, which is a PCell (S2150). The RRC layer of the base station may transmit an SCell configuration change message to the terminal. According to the SCell configuration change message, cell 1, which was PCell, may be transitioned to SCell 2.

The RRC layer of the base station may transmit an SCell release message to the terminal (S2155). According to the SCell release message, secondary cells configured for the terminal may be released. The RRC layer may transmit an SCell change instruction to the scheduler (S2160).

In the exemplary embodiments, an SCell configuration message, an SCell configuration change message, or a PCell change message transmitted to the terminal may be based on measurement reports periodically received from the terminal by the base station.

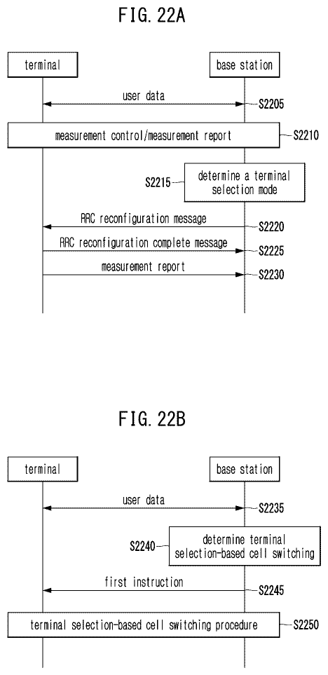

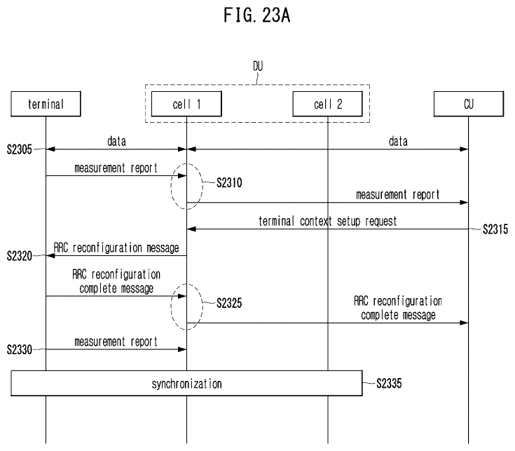

FIG. 22A and FIG. 22B are sequence diagrams illustrating exemplary embodiments of a terminal selection-based cell switching procedure.

Referring to FIG. 22A, a terminal in an RRC connected state may transmit and receive user data with a base station (S2205). The terminal may periodically transmit measurement reports to the base station (S2210). The measurement reports may include measurement results for at least one of secondary cells or a primary cell configured for the terminal. The measurement results may include quality of signals received from the cells. The base station may control transmission of a measurement report by the terminal (S2210). Control of transmission of the measurement report may be achieved by measurement configuration information.

The base station may determine a terminal selection mode (S2215). The terminal selection mode may refer to a mode in which the terminal is able to autonomously select one of neighboring cells. The base station may transmit first configuration information including at least one of neighboring cell information or configuration information indicating that the terminal autonomously selects one of neighboring cells through an RRC reconfiguration message (S2220). In other words, the first configuration information may be configuration information for selecting a target cell by the terminal. The neighboring cell information may be information on a secondary cell group.

Each of secondary cells included in the secondary cell group may be in one of four states according to the exemplary embodiments illustrated in FIG. 18. The RRC reconfiguration message may further include state information of each of cells configured for the terminal. In another example, the neighboring cell information may be information on a secondary cell group including secondary cells in the PCell candidate state. The first configuration information may further include access information for the terminal to access each of secondary cells included in the secondary cell group. The first configuration information may include broadcast-related configuration information for secondary cells included in the secondary cell group. The terminal may complete preparation to autonomously select one of neighboring cells. The terminal that has completed the preparation may transmit an RRC reconfiguration complete message to the base station (S2225).

The terminal may transmit a measurement report to the base station (S2230). The measurement report may include measurement results for secondary cells indicated by the first configuration information. Referring to FIG. 22B, the terminal in the RRC connected state may transmit and receive user data with the base station (S2235). The base station may determine terminal selection-based cell switching based on the measurement report (S2240). For example, when the base station detects an SCell showing better quality than quality of a current PCell, the base station may determine terminal selection-based cell switching. The base station may transmit a first instruction indicating terminal selection-based cell switching to the terminal (S2245).

The terminal and the base station may perform a terminal selection-based cell switching procedure (S2250). The terminal selection-based cell switching procedure may be a primary cell switching procedure. The terminal selection-based cell switching procedure may be as follows. The terminal that receives the first instruction may determine a cell showing the best quality among neighboring cells indicated by the neighboring cell information. The terminal may determine one of secondary cells in the PCell candidate state according to the first configuration information as a target primary cell. The terminal may transmit a command indicating switching to the target primary cell to the base station. The base station may perform target primary cell switching. The above-described procedures (e.g. transmission of a measurement report, determination of terminal selection-based cell switching, and performance of the terminal selection-based cell switching procedure) may be repeated.

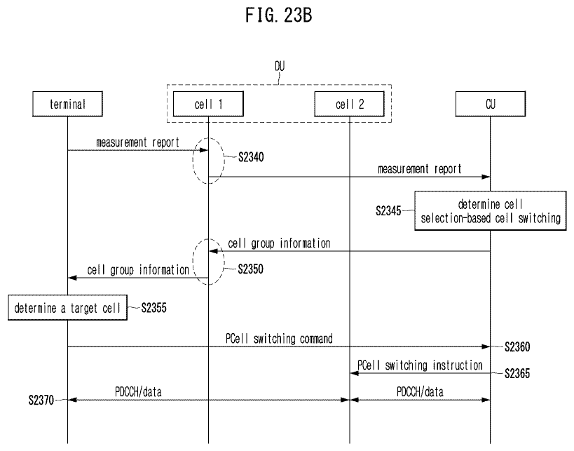

FIG. 23A and FIG. 23B are sequence diagrams illustrating exemplary embodiments of a terminal selection-based cell switching procedure.

Referring to FIG. 23A, a terminal in an RRC connected state may transmit and receive data with a central unit (CU) through cell 1, which is a primary cell (S2305). The terminal may transmit a measurement report to the CU through cell 1 (S2310). The CU may control transmission of the measurement report through measurement configuration information. The CU may determine a terminal selection mode based on the measurement report. The terminal selection mode may refer to a mode in which the terminal is able to autonomously select one of neighboring cells. The CU that determines the terminal selection mode may transmit a terminal context setup request to cell 1 (S2315).

The terminal context setup request may include at least one of neighboring cell information or configuration information indicating that the terminal autonomously selects one of neighboring cells. The neighboring cell information may be information on a secondary cell group. Secondary cells included in the secondary cell group may be in one of four states according to the exemplary embodiments illustrated in FIG. 18. The terminal context setup request may further include state information of each of cells configured for the terminal. In another example, the neighboring cell information may be information on a secondary cell group including secondary cells in the PCell candidate state.

Cell 1 may transmit an RRC reconfiguration message to the terminal (S2320). The RRC reconfiguration message may include at least one of the neighboring cell information or configuration information indicating that the terminal autonomously selects one of neighboring cells. The terminal may complete preparation to autonomously select one of neighboring cells. The terminal that completes the preparation may transmit an RRC reconfiguration complete message to the CU through cell 1.

The terminal may periodically transmit a measurement report to the CU through cell 1 (S2330). The measurement report may include measurement results for secondary cells included in the secondary cell group indicated by the neighboring cell information. After transmitting the measurement report, the terminal may check whether synchronization with cell 1 and cell 2 is acquired. When synchronization is not acquired, the terminal may perform synchronization with cell 1 and cell 2 (S2335).

The terminal may periodically transmit a measurement report to the CU through cell 1 (S2340). The CU may determine terminal selection-based cell switching based on the measurement report (S2345). The CU may transmit a first instruction indicating determination of terminal selection-based cell switching to the terminal through cell 1 (S2350). The first instruction may include cell group information. The terminal that receives the first instruction may determine a secondary cell showing the best quality among secondary cells indicated by the cell group information or the neighboring cell information as a target PCell (S2355). The terminal may transmit a PCell switching command indicating switching to the target PCell to the CU (S2360). The CU may transmit a PCell switching instruction to cell 2 (S2365). The terminal may transmit and receive control signals (e.g. PDCCH) and data with the CU through cell 2 (S2370).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
transmitting a measurement report to a base station;
receiving, from the base station, first configuration information generated based on the measurement report, wherein the first configuration information is configuration information for target cell selection by the terminal;
determining a target cell based on the first configuration information;
transmitting, to the base station, a command instructing switching to the target cell; and
performing communication with the target cell.

2. The method according to claim 1, wherein the measurement report includes measurement results for cells configured for the terminal, and the measurement results include a quality of a signal received from each of the cells.

3. The method according to claim 1, wherein the first configuration information includes at least one of: information on a secondary cell group, state information of each of secondary cells included in the secondary cell group, broadcast-related configuration information for the secondary cells, or access information for the terminal to access each of the secondary cells.

4. The method according to claim 3, wherein the state information indicates one of an active state, an inactive state, a candidate state, or a configured state, the candidate state indicates a state in which a secondary cell is capable of being transitioned to a primary cell, and the configured state indicates a state in which the secondary cell is configured as the primary cell.

5. The method according to claim 3, wherein the broadcast-related configuration information includes at least one of: information indicating whether each of the secondary cells performs broadcasting, or a broadcast start time of a secondary cell determined to perform broadcasting among the secondary cells.

6. The method according to claim 4, wherein control information is not transmitted from a secondary cell that is in the candidate state capable of being transitioned to the primary cell.

7. The method according to claim 4, wherein the target cell is determined from among secondary cells that are indicated by the first configuration information and are in the candidate state capable of being transitioned to the primary cell.

8. The method according to claim 1, further comprising: receiving, from the base station after receiving the first configuration information, a first instruction indicating terminal-selection-based cell switching, and the target cell is determined further based on the first instruction.

9. The method according to claim 1, further comprising:
checking whether synchronization with cells configured for the terminal is acquired after receiving the first configuration information; and
performing synchronization with the cells based on a result of the checking.

10. A method of a base station, comprising:
receiving a measurement report from a terminal;
determining a secondary cell group based on the measurement report;
transmitting, to the terminal, first configuration information including information on the secondary cell group, wherein the first configuration information is configuration information for target cell selection by the terminal;
receiving, from the terminal, a command instructing switching to a target cell selected by the terminal; and
performing communication with the terminal through the target cell.

11. The method according to claim 10, wherein the first configuration information includes at least one of: state information of each of secondary cells included in the secondary cell group, broadcast-related configuration information for the secondary cells, or access information for the terminal to access each of the secondary cells.

12. The method according to claim 11, wherein the state information indicates one of an active state, an inactive state, a candidate state, or a configured state, the candidate state indicates a state in which a secondary cell is capable of being transitioned to a primary cell, and the configured state indicates a state in which the secondary cell is configured as the primary cell.

13. The method according to claim 12, wherein the broadcast-related configuration information includes at least one of: information indicating whether each of the secondary cells performs broadcasting, or a broadcast start time of a secondary cell determined to perform broadcasting among the secondary cells.

14. The method according to claim 10, further comprising: determining, after receiving the measurement report, whether each of secondary cells associated with the measurement report performs broadcasting.

15. The method according to claim 11, wherein the first configuration information includes at least one of: information indicating whether each of the secondary cells performs broadcasting, or a broadcast start time at which secondary cells determined to perform broadcasting among the secondary cells start broadcasting.

16. A terminal comprising at least one processor, wherein the at least one processor causes the terminal to perform:
transmitting a measurement report to a base station;
receiving, from the base station, first configuration information generated based on the measurement report, wherein the first configuration information is configuration information for target cell selection by the terminal;
determining a target cell based on the first configuration information;
transmitting, to the base station, a command instructing switching to the target cell; and
performing communication with the target cell.

17. The terminal of claim 16, wherein the measurement report includes measurement results for cells configured for the terminal, and the measurement results include a quality of a signal received from each of the cells.

18. The terminal of claim 16, wherein the first configuration information includes at least one of: information on a secondary cell group, state information of each of secondary cells included in the secondary cell group, broadcast-related configuration information for the secondary cells, or access information for the terminal to access each of the secondary cells.

19. The terminal of claim 18, wherein the state information indicates one of an active state, an inactive state, a candidate state, or a configured state, the candidate state indicates a state in which a secondary cell is capable of being transitioned to a primary cell, and the configured state indicates a state in which the secondary cell is configured as the primary cell.

20. The terminal of claim 18, wherein the broadcast-related configuration information includes at least one of: information indicating whether each of the secondary cells performs broadcasting, or a broadcast start time of a secondary cell determined to perform broadcasting among the secondary cells.
